(19) United States
(12) Patent Application Publication
(10) Pub. No.: US 2024/0189930 A1
(43) Pub. Date: Jun. 13, 2024

(54) WORKPIECE CLAMPING DEVICE AND SPINDLE ARRANGEMENT FOR A MACHINE TOOL

(71) Applicant: Klingelnberg AG, Zürich (CH)

(72) Inventors: Christian Brieden, Hückeswagen (DE); Matthias Daniels, Bergisch Gladbach (DE); Stefan Herzhoff, Hückeswagen (DE); Sergej Osnitzki, Hückeswagen (DE)

(21) Appl. No.: 18/523,348

(22) Filed: Nov. 29, 2023

(30) Foreign Application Priority Data
Dec. 9, 2022 (DE) 10 2022 132 886.4

(51) Int. Cl. B23F 23/06

(52) U.S. Cl. CPC B23F 23/06

(57) ABSTRACT

A spindle arrangement for a machine tool, having a spindle shaft, having a workpiece clamping device for accommodating and clamping an internally-toothed ring gear, wherein the workpiece clamping device is designed as cup-shaped and has a circumferential collar, wherein the circumferential collar delimits an opening for accommodating and clamping an internally-toothed ring gear. The workpiece clamping device further includes a damping device, which has an oscillating mass, damping elements, and spring elements, wherein the oscillating mass, the damping elements, in the spring elements are arranged outside the opening in the area of an outer side of the collar facing away from the opening.

The present invention relates to a workpiece clamping device and a spindle arrangement for a machine tool.

During the production of the gear teeth of an internally-toothed ring gear, the relevant ring gear is accommodated in a workpiece clamping device. The gear teeth can be produced, for example, by skiving. During the cutting removal, the workpiece clamping device and the ring gear are excited to oscillate by the machining forces. This is because each cutting removal by a relevant skiving tool is accompanied by an engagement shock during the penetration of a respective cutting edge into the material of the ring gear, forces changing in amount and direction during the removal of the chip, and an exit shock upon detaching the chip from the ring gear.

Such oscillations can, on the one hand, result in damage to the cutting edges of the tool. On the other hand, such oscillations generate visible and measurable marks on the tooth flanks of the teeth of the gear teeth to be produced of the internally-toothed ring gear, which are possibly counter to maintaining the required manufacturing accuracy and are often undesired by customers, even if the quality is not impaired.

Against this background, the present invention is based on the technical problem of specifying a workpiece clamping device and a spindle arrangement for a machine tool, which enable reliable manufacturing of ring gears and in particular reduce oscillations as a result of machining forces. The above-described technical problem is achieved by the features of each of the independent claims. Further embodiments of the invention result from the dependent claims in the following description.

A workpiece clamping device is specified according to the invention, wherein the workpiece clamping device is designed as cup-shaped and has a circumferential collar, wherein the circumferential collar delimits an opening for accommodating and clamping an internally-toothed ring gear, having a damping device which has an oscillating mass, damping elements, and spring elements, wherein the oscillating mass, the damping elements, and the spring elements are arranged outside the opening in the area of an outer side of the collar facing away from the opening.

The damping device can damn oscillations which occurred during the machining of the internally-toothed ring gear due to machining forces. The quality of the gear teeth of the internally-toothed ring gear can be improved in this way. The term “quality” relates in this case to measurable component deviations and/or the subjective visual impression of the finished tooth flanks.

The damping device is an integral component of the workpiece clamping device. The damping device has, in the fully assembled state, in particular a spacing to a spindle shaft of a spindle arrangement. The damping device is, in the fully assembled state, in particular not fastened on a spindle shaft of a spindle arrangement and/or in particular does not bear on a spindle shaft of a spindle arrangement. It can be provided that the damping devices exclusively fastened on the collar and in particular does not bear on a spindle shaft of a spindle arrangement in the fully assembled state.

The workpiece clamping device is in particular a workpiece clamping device of a machine tool, in particular for producing gear teeth.

The workpiece clamping device is in particular a workpiece clamping device of a machine tool, in particular for producing gear teeth.

It can be provided that the damping device is configured for damping one or more interfering frequencies of a machining process.

The collar of the workpiece clamping device can be made annular.

The workpiece clamping device can be made essentially rotationally symmetrical to a spindle axis of a spindle arrangement in the fully assembled state.

The oscillating mass can be a ring, which encloses the collar of the workpiece clamping device on the circumferential side. A compact integration of the oscillating mass in the workpiece clamping device can thus be achieved without the oscillating mass restricting the possible movement of a tool relative to the workpiece. In particular, the oscillating mass is therefore not a collision structure which is to be taken into consideration during the engagement of the tool with the ring gear.

A spacing can be formed between the oscillating mass and the collar, in particular a gap can be formed. Because the oscillating mass does not bear on the collar, the damping properties of the damping device can be improved. Providing the oscillating mass is a ring and the collar is also made annular, the gap can be designed in particular as a circular circumferential ring gap.

The damping elements can bear on the oscillating mass. The damping properties of the damping device can be improved in this way. The feature “bear on” comprises in particular touching, bearing on without a gap, bearing on one another without force, or a state clamped to one another. The damping elements can comprise an elastic damping material or can consist of an elastic damping material.

The damping elements can comprise a plastic or can consist of a plastic, for example.

The damping elements can comprise a rubber or can consist of a rubber, for example, in particular a natural rubber or the like.

The damping elements can comprise a composite material or can consist of a composite material, for example. The composite material can in particular be a metallic material and can comprise a further material, such as a plastic, rubber, or the like.

The damping elements can comprise a metallic material or consist of a metallic material, for example. The damping elements are used in particular to absorb oscillation energy.

The workpiece clamping device can have a centering cover, which is connected to an end face of the collar, wherein the damping device is held on the centering cover. The damping device can therefore be connected to the collar or held on the collar via the centering cover.

In particular, it can be provided that the centering cover extends protruding beyond the collar in the radial direction. In other words, the centering cover has a larger diameter than the collar. In this way, the area of the centering cover protruding beyond the collar can be used for fastening the damping device on the centering cover.

The centering cover can be connected to the collar by screws, for example. In particular, threaded boreholes can be incorporated into the end face of the collar, so that the centering cover can be screwed onto the collar with the aid of screws.

The centering cover can have a shoulder, which forms a receptacle and encloses the collar on the circumferential side at least in some sections. In particular, an inner lateral surface of the centering cover bears on an outer lateral surface of the collar in order to achieve centering relative to the collar. In this way, the damping device can be aligned and repeatably positioned relative to the collar with the aid of the centering cover.

At least a part of the damping elements can be arranged, in particular clamped, between the centering cover and the oscillating mass. In this way, damping takes place between the centering cover and oscillating mass provided that the centering cover and/or the oscillating mass are set into oscillations.

The workpiece clamping device can have a lid, wherein damping elements are arranged, in particular clamped, between the lid and oscillating mass.

The lid can be designed as annular, for example. The lid can enclose the collar on the circumferential side. The lid can in particular be arranged on a side of the oscillating mass facing away from the centering cover. In particular, it can be provided that the oscillating mass is arranged between the centering cover and the lid, wherein the oscillating mass is in particular enclosed on two sides by the lid and the centering cover.

It can be provided that the cover is connected by screws to the oscillating mass.

The spring elements of the damping device can be screw connections, for example.

It can be provided that the lid and oscillating mass are held by means of the screw connections on the centering cover. In particular, it can be provided that screws and/or threaded rods of the screw connections penetrate the centering cover, the oscillating mass, and the cover.

The cover and/or the oscillating mass and/or the centering cover can have passage openings for inserting through or receiving a respective screw shaft and/or a respective threaded rod of a respective screw connection.

The damping elements can be arranged in pairs with a radial spacing to one another. The radial direction relates here in the fully assembled state to a perpendicular to a spindle axis of a spindle shaft in each case.

Alternatively or additionally, the damping elements can be arranged distributed at equidistant angular spacings relative to one another. Provided that four damping elements are provided, for example, an angular spacing between two adjacent damping elements can be 90° in each case, measured from a center of a respective damping element. Accordingly, an angular spacing of 120° would result for an arrangement of three damping elements.

For example, three or four pairs of damping elements can be provided which are arranged relative to one another at equidistant angular spacings, in particular in the fully assembled state are arranged in equidistant angular spacings around a spindle axis of a spindle shaft.

The damping elements can have, for example, a circular cross section and can be sealing cords, for example. A respective sealing cord can have, for example, a diameter of greater than or equal to 5 mm and can have a diameter of less than or equal to 20 mm. For example, it can be provided that the sealing cords each have a diameter of 10 mm.

It can be provided that the oscillating mass has recesses for accommodating the damping elements. For example, it can be provided that a groove is provided on the oscillating mass as a recess for accommodating the damping elements. In particular, it can be provided that recesses for accommodating the damping elements are formed on sides of the oscillating mass facing away from one another.

For example, it can be provided that the oscillating mass has recesses spaced apart radially in relation to one another for accommodating the damping elements.

Provided that sealing cords are provided as the damping elements, for example, it can be provided that the oscillating mass has circular circumferential grooves for accommodating the sealing cords. For example, it can be provided that two circular circumferential grooves radially spaced apart from one another are provided for accommodating sealing cords on sides of the oscillating mass facing away from one another.

According to alternative embodiments, it can be provided that damping elements have a rectangular or an oval cross section. In particular, the cross-sectional shape can be matched to a provided receptacle of the damping elements and/or to a respective damping effect to be generated.

Furthermore, the invention relates to a spindle arrangement for a machine tool, having a spindle shaft and having a workpiece clamping device according to the invention, wherein the workpiece clamping device is fastened on the spindle shaft.

The spindle shaft can be designed essentially rotationally symmetrical to a spindle axis.

The spindle shaft can be rotatably mounted inside a housing.

The invention is described in more detail hereinafter on the basis of a drawing illustrating exemplary embodiments. In the schematic figures:

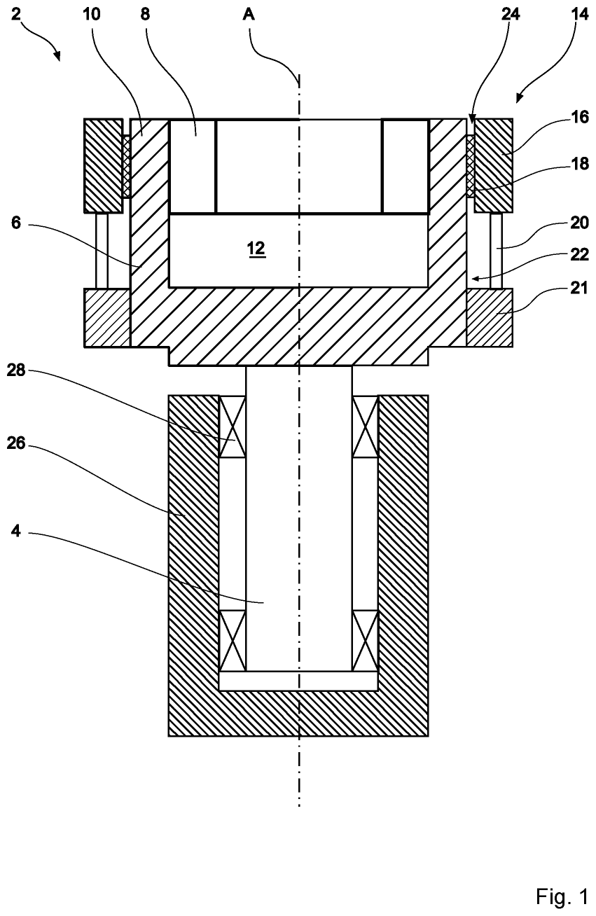

FIG. 1 shows a first spindle arrangement according to the invention having a workpiece clamping device according to the invention;

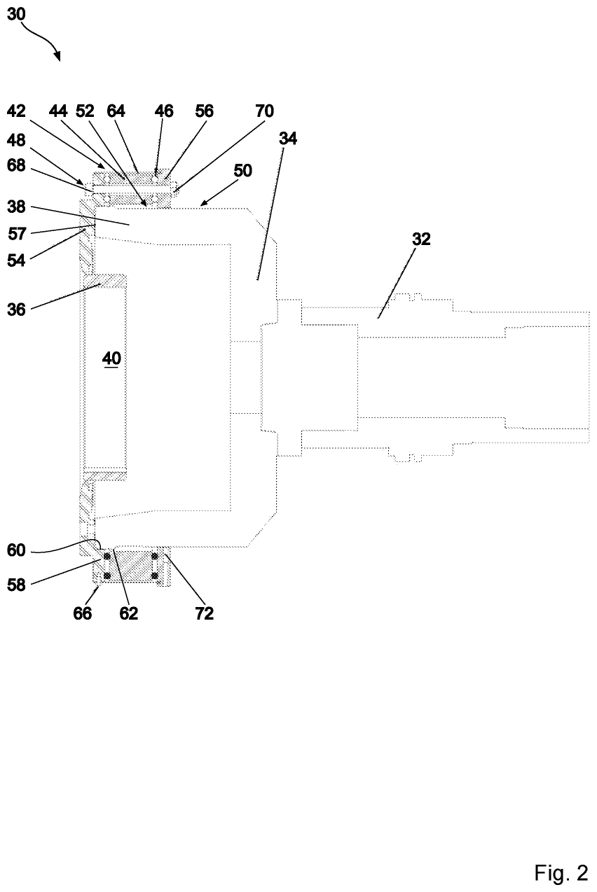

FIG. 2 shows a second spindle arrangement according to the invention in a sectional view having a further workpiece clamping device according to the invention;

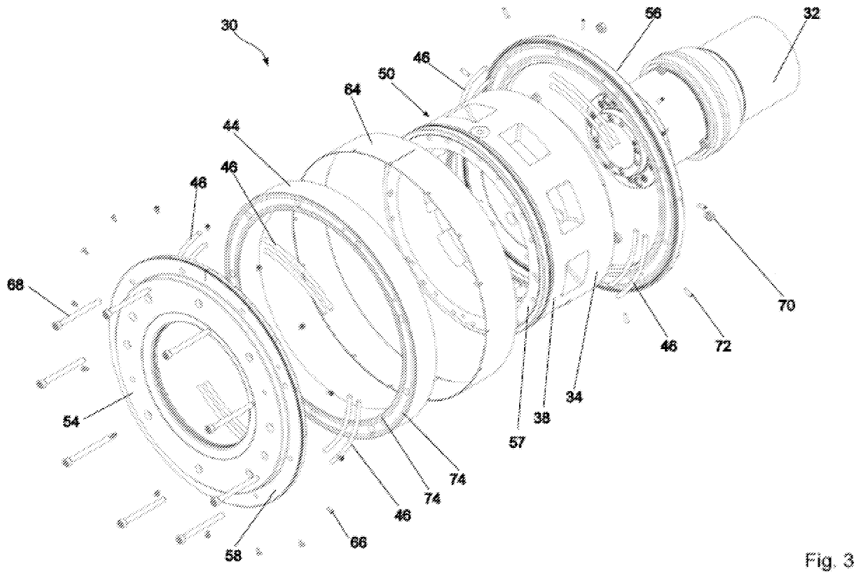

FIG. 3 shows the second spindle arrangement according to the invention in a prospective exploded view.

FIG. 1 shows a first spindle arrangement 2 according to the invention in a sectional view.

The spindle arrangement 2 is a spindle arrangement for a machine tool. The spindle arrangement 2 has a spindle shaft 4. The spindle arrangement 2 has a workpiece clamping device 6 for accommodating and clamping an internally-toothed ring gear 8.

The workpiece clamping device 6 is fastened on the spindle shaft 4. The workpiece clamping device 6 is designed as cup-shaped and has a circumferential collar 10. The circumferential collar 10 delimits an opening 12 for accommodating the internally-toothed ring gear 8.

The circumferential collar 10 is annular and has a circular-cylindrical shape.

The workpiece clamping device 6 is designed as rotationally symmetrical to a spindle axis A of the spindle shaft 4, wherein the spindle axis A is at the same time an axis of rotation of the spindle shaft 4, around which the spindle shaft 4 is rotatably mounted.

The spindle arrangement 2 has a damping device 14.

The damping device 14 has an oscillating mass 16, damping elements 18, and spring elements 20. The damping device 14 is connected by means of a fastening element 21 to the workpiece clamping device 6.

The oscillating mass 16, the damping elements 18, and the spring elements 20 are arranged outside the opening 12 in the area of an outer side 22 of the collar 10 facing away from the opening 12.

The oscillating mass 16 is a ring 16 which encloses the collar 10 on the circumferential side. A spacing in the form of a gap 24 is formed between the ring 16 and the collar 10.

The damping elements 18 are accommodated in the gap 24 between the ring 16 and the collar 10. The damping elements 18 bear both on the ring 16 and on the collar 10.

The damping elements 18 comprise a plastic material. The spring elements 20 and the oscillating mass 16 comprise a metallic material.

The spindle shaft 4 is rotatably mounted in a fixed housing 26, wherein two bearings 28 are shown in the present case.

FIG. 2 shows a second spindle arrangement 30 according to the invention for a machine tool.

The spindle arrangement 30 has a spindle shaft 32. The spindle arrangement 30 has a workpiece clamping device 34 for accommodating and clamping an internally-toothed ring gear 36. The workpiece clamping device 34 is fastened on the spindle shaft 32.

The workpiece clamping device 34 is designed as cup-shaped and has a circumferential collar 38, which delimits an opening 40 for accommodating the internally-toothed ring gear 36.

The spindle arrangement 30 has a damping device 42. The damping device 42 has an oscillating mass 44, damping elements 46, and spring elements 48.

The oscillating mass 44, the damping elements 46, and the spring elements 48 are arranged outside the opening 40 in the area of an outer side 50 of the collar 38 facing away from the opening 40.

The oscillating mass 44 is a ring 44, which encloses the collar 38 on the circumferential side. A spacing in the form of a circular circumferential ring gap 52 is provided between the oscillating mass 44 and the collar 38.

The damping elements 46 bear on the oscillating mass 44.

The spindle arrangement 30 has a centering cover 54, which is connected by screws in the area of an end face 57 of the collar 38.

The damping device 42 is held on the centering cover 54.

Damping elements 46 of the damping device 42 are held between the centering cover 54 and the oscillating mass 44.

The spindle arrangement 30 has a lid 56, wherein damping elements 46 of the damping device 42 are arranged between the lid 56 and oscillating mass 44.

The damping elements 46 of the damping device 42 are clamped between the cover 56, the oscillating mass 44, and the centering cover 54.

The spring elements 48 are screw connections in the present case, wherein the screw connections 48 are used at the same time to clamped the damping elements 46 between the lid 56, the oscillating mass 44, and the centering cover 54.

The centering cover 54 has a shoulder 58, which forms a receptacle and encloses the collar 38 on the circumferential side at least in some sections. An inner lateral surface 60 of the centering cover 54 bears on an outer lateral surface 62 of the collar 38 in order to achieve centering of the damping device 42 relative to the collar or on the collar 38.

A diameter of the workpiece clamping device 34 is smaller than a diameter of the centering cover 54. The damping device 42 is connected by screws to the centering cover 54 in the area protruding radially beyond the diameter of the workpiece clamping device 34.

Furthermore, a radial lid 64 is provided, which encloses the oscillating mass 44 on the circumferential side. The radial lid 64 is connected by screws by means of a screw connection 66 to the centering cover 54.

The screw connections 48 have a screw 68 and a nut 70 in the present case. A screw shaft of the screw 68 penetrates an assigned passage opening of the centering cover 54, the oscillating mass 44, and the cover 56 in each case.

A threaded pin 72, which bears on the collar 38, is seated in the lid 46.

FIG. 3 shows the spindle arrangement 30 according to the invention in a prospective exploded view.

The damping elements 46 are arranged in pairs with a radial spacing to one another in the present case. Moreover, the pairs of the damping elements 46 are arranged distributed relative to one another at equidistant angular spacings.

The damping elements 46 have a circular cross section and are sealing cords.

The oscillating mass 44 has groups 74 spaced apart radially from one another, which are used to accommodate the sealing cords 46.

The cover 56 has a clearance fit with the collar 38, i.e., a spacing or gap is formed between the cover 56 and the collar. The threaded pins 72 are used to fix the cover 56 on the collar 38.

The radial lid 64 is seated with play in the cover 56. The radial lid 64 can therefore execute torsional oscillations relative to the cover 56 and vice versa.

### LIST OF REFERENCE NUMERALS

2, 30 spindle arrangement
4, 32 spindle shaft
6, 34 workpiece clamping device
8, 36 internally-toothed ring gear
10, 38 circumferential collar
12, 40 opening
14, 42 damping device
16, 44 oscillating mass
18, 46 damping element/sealing cord
20, 48 spring elements/screw connections
21 fastening element
22, 50 outer side
24, 52 gap/ring gap
26 housing
28 bearing
54 centering cover
56 lid
57 end face
58 shoulder
60 inner lateral surface
62 outer lateral surface
64 radial cover
66 screw connections
68 screw
70 nut
72 threaded pin
74 groove

1. A workpiece clamping device,
wherein the workpiece clamping device is designed as cup-shaped and has a circumferential collar,
wherein the circumferential collar delimits an opening for accommodating and clamping an internally-toothed ring gear,
having a damping device, which has an oscillating mass, damping elements, and spring elements,
wherein the oscillating mass, the damping elements, in the spring elements are arranged outside the opening in the area of an outer side of the collar facing away from the opening.

2. The workpiece clamping device as claimed in claim 1,
wherein the oscillating mass is a ring, which encloses the collar on a circumferential side.

3. The workpiece clamping device as claimed in claim 1,
wherein a spacing is formed between the oscillating mass and the collar, in particular a gap is formed.

4. The workpiece clamping device as claimed in claim 1,
wherein the damping elements bear on the oscillating mass.

5. The workpiece clamping device as claimed in claim 1,
wherein a centering cover is provided, which is connected to an end face of the collar, wherein the damping device is held on the centering cover.

6. The workpiece clamping device as claimed in claim 5,
wherein at least a part of the damping elements are arranged between the centering cover and oscillating mass.

7. The workpiece clamping device as claimed in claim 1,
wherein a lid is provided, wherein damping elements are arranged between the lid and the oscillating mass.

8. The workpiece clamping device as claimed in claim 1,
wherein the spring elements are screw connections.

9. The workpiece clamping device as claimed in claim 6,
wherein the lid and the oscillating mass are held by of the screw connections on the centering cover, whereby screws and/or threaded rods of the screw connections penetrate the centering cover, the oscillating mass, and the cover.

10. The workpiece clamping device as claimed in claim 1,
wherein the damping elements are arranged in pairs with a radial spacing to one another
and/or
the damping elements are arranged distributed at equidistant angular spacings relative to one another
and/or
the damping elements have a circular cross section.

11. A spindle arrangement for a machine tool,
having a spindle shaft and
having a workpiece clamping device as claimed in claim 1,
wherein the workpiece clamping device is fastened on the spindle shaft.
